(19) United States
(12) Patent Application Publication
(10) Pub. No.: US 2016/0037552 A1
(43) Pub. Date: Feb. 4, 2016

(54) METHOD AND APPARATUS TO ADAPT THE NUMBER OF HARQ PROCESSES IN A DISTRIBUTED NETWORK TOPOLOGY

(71) Applicants: ZTE WISTRON TELECOM AB, Kista (SE); ZTE (TX) INC., Austin, TX (US)

(72) Inventors: Patrick Svedman, Kista (SE); Jan Johansson, Kista (SE); Thorsten Schier, Kista (SE); Bojidar Hadjiski, Kista (SE); Aijun Cao, Kista (SE); Yonghong Gao, Kista (SE)

(21) Appl. No.: 14/774,643

(22) PCT Filed: Mar. 14, 2014
(86) PCT No.: PCT/US14/28833

§ 371 Date: Sep. 10, 2015

Related U.S. Application Data
(60) Provisional application No. 61/784,395, filed on Mar. 14, 2013.
(60) Provisional application No. 61/824,762, filed on May 17, 2013.
(60) Provisional application No. 61/857,059, filed on Jul. 22, 2013.

(51) Int. Cl. H04W 72/12; H04L 12/751; H04L 1/18

(52) U.S. Cl. CPC H04W 72/1273; H04L 1/1887; H04L 45/02

(57) ABSTRACT

A system includes a downlink transmitter unit, a downlink scheduler unit, and an uplink receiver unit. At least one of the units is located at a physically separate location from others of the units, and the at least one of the units communicates with the others of the units over a backhaul. A controller that allocates a number of hybrid automatic repeat request (HARQ) processes according to any communication delays caused by the backhaul.

### CROSS-REFERENCE TO RELATED APPLICATIONS

This application claims benefit of priority under 35 U.S.C. §119(e) to Provisional Application Nos. 61/784,395, 61/824,762 and 61/857,059, all titled “Method and Apparatus to Adapt the Number of HARQ Processes in a Distributed Network Topology”, filed Mar. 14, 2013, May 17, 2013, and Jul. 22, 2013, respectively, each of which is incorporated by reference herein in its entirety.

### FIELD OF THE INVENTION

The present invention relates generally to the field of cellular communications, and more particularly to methods and apparatus to adapt a number of Hybrid Automatic Repeat reQuest (HARQ) processes in a distributed network topology to compensate for backhaul delays among network components.

### BACKGROUND OF THE INVENTION

In order to improve the performance of digital communication systems, retransmission protocols are often used. The digital information is often grouped in blocks or packets. The successful reception of a block of data can be detected by the receiver by using for example a cyclic redundancy check (CRC). The unsuccessful reception of a block can in some situations or systems be ignored by the receiver. In other situations or systems, the receiver may inform the transmitter of the result of the reception of a block, using for example an ACK/NACK, where an ACK (ACKnowledgement) indicates that the block was successfully received and a NACK (Negative ACKnowledgement) indicates that the block was not successfully received. For example, the LTE RLC (Radio Link Control) provides three different data transmission modes: transparent mode (TM), unacknowledged mode (UM) and acknowledged mode (AM). Only RLC blocks transmitted in AM can be acknowledged by the receiving RLC and retransmitted by the transmitting RLC. For the other two modes, an incorrectly received RLC block is simply discarded.

Many digital communication systems follow a layered model, for example the OSI model or the TCP/IP model. In a layered system, there may be retransmission protocols in multiple layers. Data is to be transmitted from the “Transmitter” to the “Receiver”. Note that also a reverse link between the “Receiver” and the “Transmitter” is needed, for example to feedback ACK/NACKs. A layered system includes for example layer 1 (L1), layer 2 (L2) and layer 3 (L3). Both L2 and L3 use retransmission protocols. The L2 receiver responds to the L2 transmitter with an ACK/NACK at the successful/unsuccessful reception of an L2 block. Similarly. the L3 receiver responds to the L3 transmitter with an ACK/NACK at the successful/unsuccessful reception of an L3 block. Note that there is not necessarily direct correspondence between an L2 block and an L3 block, i.e. an L2 block can carry multiple L3 blocks or only a part of one L3 block.

This disclosure applies to examples in which the lowest level retransmission protocol (e.g. the L2 retransmission protocol) uses Hybrid Automatic Repeat reQuest (HARQ) with soft combining as well as to other examples. For simplicity and without loss of generality, the disclosure is described in conjunction with an example in which L2 uses a HARQ protocol with soft combining. For simplicity and without loss of generality, the disclosure is described in conjunction with an example in which the next layer above L2 that uses a retransmission protocol is L3. This choice matches the LTE retransmission protocol, where L2 (MAC) uses HARQ with soft combining and L3 (RLC) uses retransmissions for data in AM.

An example of L2 HARQ with soft combining is described below:

The receiver L2 responds with an ACK/NACK a known time delay after the transmission of the L2 block.
a. In the LTE FDD downlink for example, the UE should respond with an ACK/NACK (on PUCCH or on PUSCH) 4 sub-frames after the transmission of the corresponding transport block.
b. In the LTE FDD uplink for example, the eNodeB should respond with an ACK/NACK (explicitly on PHICH or implicitly on PDCCH) 4 sub-frames after the transmission of the corresponding L2 transport block.
c. In LTE TDD for example, the ACK/NACK time delay after the transmission of the corresponding transport block depends on the TDD uplink/downlink configuration. Since the configuration is known, the time delay can also be deduced.
   If the receiver L2 responds with a NACK, i.e. the L2 block was incorrectly received, then the receiver keeps the soft bits of the incorrectly received block in its soft bit memory.
d. The stored soft bits can be softly combined with a subsequent retransmission to improve the probability of a successful reception.
e. If the L2 block was correctly received, there is no need to keep the corresponding soft bits in the memory.

Multiple parallel HARQ processes are used.
f. A transmission of an L2 block is connected to one HARQ process.
g. Retransmissions of an L2 block needs to be done using the same HARQ process as the first transmission of the block.
h. The receiver keeps a soft bit memory buffer for each HARQ process.
i. A retransmission on a HARQ process is softly combined in the receiver with the soft bits in the memory buffer for the same HARQ process.
j. The different HARQ processes can be distinguished through different HARQ process indices.

The L2 transmitter may transmit a new L2 block on a HARQ process when
k. it knows/recognizes that the previous L2 block of the same HARQ process was received correctly, or
l. the maximum number of retransmissions was reached of the previous L2 block of the same HARQ process.
   The L2 receiver may let the soft bits of a new L2 block overwrite the soft bits of the previous L2 block of the same HARQ process.

In some example systems, multiple blocks (e.g. L2 blocks) can be transmitted from a transmitter to a receiver at the same time, with the receiver responding with multiple corresponding ACK/NACKs, or a combination thereof. In one example, these multiple blocks and corresponding multiple ACK/NACKs (or a combination thereof) are connected to the same HARQ process, and the individual blocks could be seen as connected to sub-processes of the HARQ process. In another example, these multiple blocks and corresponding multiple ACK/NACKs (or a combination thereof) are connected to different HARQ processes. Both these cases are covered by this disclosure. However, for simplicity and readability, the case with a single block per HARQ process and time is described herein.

In some example systems, such as some TD-LTE downlink configurations with bundling, the ACK/NACKs of multiple HARQ processes are bundled into a single ACK/NACK. These cases are also covered by this disclosure, since the receiver of a bundled ACK/NACK can draw some conclusions of the ACK/NACKs of the individual HARQ processes from the bundled ACK/NACK, and thereby request or choose retransmission or not.

A finite amount of time is required between successive transmit-ACK/NACK-transmit or retransmit cycles. During this time, a HARQ process is not used for another transmission, since this would risk overwriting the soft bits in the HARQ process memory buffer. Therefore, in order to enable the continuous transmission of data blocks, multiple HARQ processes are needed, that can run in parallel. In FDD LTE, for example, both the downlink and the uplink provides 8 HARQ processes per UE.

HARQ procedures can be categorized into asynchronous and synchronous HARQ. In asynchronous HARQ, there is no (statically or semi-statically) known time relation between a transmission of a new block and a retransmission. Instead, the retransmission needs to be explicitly scheduled, i.e. the time relation between a new block and its retransmission is dynamic.

The downlink HARQ in LTE is an example of an asynchronous HARQ. In the downlink scheduling assignment received by a UE in LTE (on PDCCH or ePDCCH), the HARQ process index is included explicitly, as well as an indication if the transmission is a retransmission. This means that, in principle, any HARQ process can be used in any (downlink) sub-frame in the downlink transmission to a UE. In synchronous HARQ, there is a (statically or semi-statically) known time relation between a transmission of a new block and a retransmission.

The uplink HARQ in LTE is an example of a synchronous HARQ. The uplink scheduling grant received by a UE in LTE (on PDCCH, ePDCCH or implicitly on PHICH) does not include an explicit HARQ process index in this example. Instead, the HARQ process index to be used in an uplink transmission is implicitly given by the sub-frame index in which the uplink scheduling grant was received. However, the uplink scheduling grant (on PDCCH, ePDCCH or implicitly on PHICH) may include an indication if the transmission should be a retransmission of the previously transmitted block on the same HARQ process in this example.

Base stations and UEs each include at least one transmitter and at least one receiver. Additionally, base stations include a scheduler for scheduling downlink transmissions. Currently, the downlink transmitter, uplink receiver and downlink scheduler are all located in the base station. The downlink receiver and the uplink transmitter are located in the UE. In the current base station architecture, the downlink transmitter, uplink receiver and downlink scheduler are all co-located in one place. However, there is a trend toward new network topologies, such as distributed network topologies, in which the downlink transmitter may be located in a node in one physical location, the uplink (ACK/NACK) receiver may be located in another node in another physical location, and the scheduler may be located in a third node in a third physical location, with these nodes being connected with non-ideal backhaul. Since the nodes are not co-located, there can be a significant backhaul delay between the reception of an ACK/NACK in the uplink receiver and the time the ACK/NACK can be used in the downlink scheduling. Similarly, there can be a significant backhaul delay between the downlink scheduling and the actual downlink transmission based on the scheduling. Thus, the downlink transmitter may not be ready to transmit the next block or retransmit the prior block when in the transmission interval allocated to the process. Instead, the downlink transmitter will have to wait until a subsequent transmission interval before performing the transmission or retransmission, resulting in a reduction of data rate from the downlink transmitter to the user equipment.

### SUMMARY OF THE INVENTION

In some embodiments, the invention is directed to solving a problem that occurs when the downlink transmitter, uplink receiver and/or scheduler in a radio network are non-co-located, i.e. a distributed network topology with backhaul delay between these devices. In this case, with limited HARQ processes, it may not be possible to use all transmission opportunities, thereby reducing the maximum data rate of the user equipment and the system efficiency.

The disclosure addresses this shortcoming and provides a method and system for using more transmission opportunities in a distributed network topology with limited HARQ processes. In some embodiments of the disclosure method, the number of HARQ processes of a UE is adapted to the backhaul delays between the network devices (which downlink transmitter, uplink receiver, etc.) that the UE uses. Also the set of other UEs that use those particular network devices can be taken into account when adapting the number of HARQ processes of a UE. By properly adapting the number of HARQ processes, the UE data rate and system efficiency can be improved.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily made to scale.

FIG. 1 illustrates an embodiment of a distributed topology cellular communications network.

FIG. 2 is signaling and processing diagram of an embodiment of a HARQ process, in a cellular network with minimal backhaul delays.

FIG. 3 is signaling and processing diagram of an embodiment of a HARQ process, in a distributed network topology with substantial backhaul delays.

FIG. 4 is a flowchart of an embodiment of transmitter controller processing according to the present disclosure.

### DETAILED DESCRIPTION OF EXEMPLARY EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

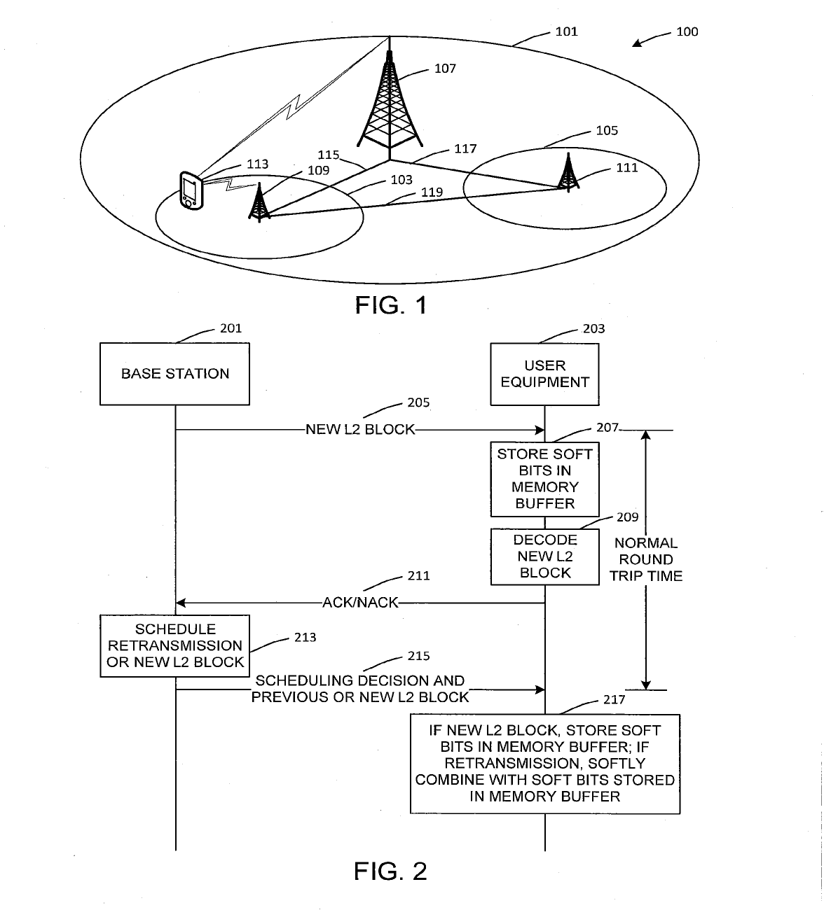

Referring now to the drawings, and first to FIG. 1, an embodiment of a distributed topology cellular telecommunications network is designated generally by the numeral 100. Network 100 comprises a large cell 101 and at least two small cells 103 and 105. Large cell 101 includes a large cell base station 107. Small cells 103 and 105 each include a small cell base station 109 and 111, respectively.

Cells 101, 103 and 105 comprise nodes of network 100. Base stations 107-111 are interconnected by backhauls 115-119. In some embodiments, base stations 107 and 109 are connected to each other by backhaul 115 and base stations 107 and 111 are connected by backhaul 117. A mobile terminal or user equipment (UE) 113 is located in cells 101 and 103.

Each base station 107, 109 and 111 may include a downlink transmitter, a downlink scheduler and an uplink receiver (not shown in FIG. 1). According to embodiments of the present disclosure, the downlink (DL) transmitter, DL scheduler and uplink (UL) receiver functions for the session with UE 113 are distributed across network 100. Specifically, base station 107 provides the DL transmitter, base station 109 provides the UL transmitter, and base station 111 provides the DL scheduler. Since base stations 109 and 111 are not co-located, there is can be a significant backhaul delay between the reception from UE 113 of an ACK/NACK in the UL receiver of base station 107 and the time the ACK/NACK can be used in the DK scheduler of base station 111. Similarly, there is can be a significant backhaul delay between the DL scheduling in base station 111 and the actual DL transmission from base station 107, based on the scheduling.

In some embodiments, the downlink transmitter may be located in multiple nodes in multiple physical locations, for example if coordinated multi-point (CoMP) with joint transmission is used. In one embodiment, these nodes or a subset thereof may be connected with non-ideal backhaul. In some embodiments, the uplink receiver may be located in multiple nodes in multiple physical locations, for example if coordinated multi-point (CoMP) with joint reception is used. In one embodiment, these nodes or a subset thereof may be connected with non-ideal backhaul. In some embodiments, the scheduler may be located in a multiple nodes in multiple physical locations. In one embodiment, these nodes or a subset thereof may be connected with non-ideal backhaul. In some embodiments, for different UEs, different functions may be located in different nodes. For instance, the downlink to one UE may be transmitted from a different node than the downlink to another UE.

To understand the backhaul delay concept better, FIG. 2 illustrates the situation where the DL transmitter, DL scheduler and UL receiver are all co-located in the same base station 201. Base station 201 transmits to UE 203 a new L2 block, as indicated at 205. UE 203 stores soft bits in its memory buffer, as indicated at process block 207, and decodes the new L2 block, as indicated at process block 209. Depending on the result of the decoding step, UE 203 transmits back to base station 201 either an ACK response or a NACK response, as indicated at 211. The DL scheduler of base station 201 schedules either a retransmission of the prior L2 block or a new L2 block, based up whether it received an ACK or a NACK, as indicated at process block 213. The transmitter of base station 201 then transmits to UE 203 the scheduling decision and the previous or the new L2 block, as indicated at 215. The time elapsed between the transmission of the new L2 block, at 205, and the receipt of the previous or new L2 block, at 215, constitutes the normal round trip time, which in LTE is eight sub-frames. If UE 203 receives a new L2 block, UE 203 stores the new L2 block in its memory buffer; if UE 203 receives a retransmitted prior L2 block, UE 203 softly combines the retransmission with the soft bits stored in its memory buffer, all as indicated at process block 217.

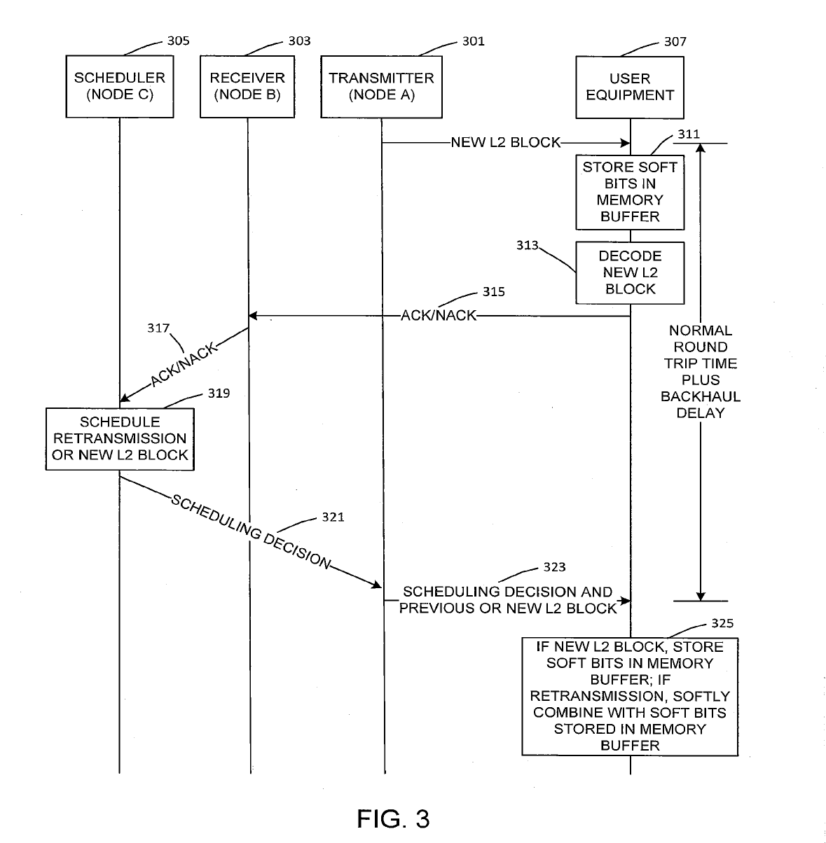

FIG. 3 illustrates the situation where a DL transmitter 301 is located at a first physical location (Node A), a UL receiver 303 is located at a second physical location (Node B), and a DL scheduler is located at a third physical location (Node C). DL transmitter 301 transmits to UE 307 a new L2 block, as indicated at 309. UE 307 stores soft bits in its memory buffer, as indicated at process block 311, and decodes the new L2 block, as indicated at process block 313. Depending on the result of the decoding step, UE 307 transmits to UL receiver 303 either an ACK response or a NACK response, as indicated at 315. UL receiver 303 transmits the ACK or NACK to DL scheduler 305 over a low speed backhaul, as indicated at 317. DL scheduler 305 schedules either a retransmission of the prior L2 block or a new L2 block, based up whether it received an ACK or a NACK, as indicated at process block 319. DL scheduler 319 then transmits to UE to DL transmitter 301 the scheduling decision over a low speed backhaul, as indicated at 321. DL transmitter 301 then transmits to UE 307 the scheduling decision and the previous or the new L2 block, as indicated at 323. The time elapsed between the transmission of the new L2 block, at 309, and the receipt of the previous or new L2 block, at 323, constitutes the normal round trip time plus the backhaul delay The actual amount of the backhaul may be as much as twenty sub-frames. If UE 307 receives a new L2 block, UE 307 stores the new L2 block in its memory buffer; if UE 307 receives a retransmitted prior L2 block, UE 307 softly combines the retransmission with the soft bits stored in its memory buffer, all as indicated at process block 325.

The increased HARQ process roundtrip time can result in that a single UE cannot be scheduled continuously, i.e. for each consecutive transmission opportunity, since the number of HARQ processes is fixed and limited. This reduces the maximum data rate of the UE. For example, consider the LTE downlink. In this example, assume that the distributed network topology is such that a retransmission on a HARQ process can occur at the earliest 20 sub-frames after the first transmission, due to backhaul delays between some of the distributed network functions (in LTE, a sub-frame is a transmission opportunity). Then, following the regular DL HARQ procedure, the UE can be scheduled in only 8 of 20 sub-frames (40%), since there are 8 DL HARQ processes in LTE. However, even though the considered UE is not scheduled continuously, another UE may be scheduled, since the HARQ processes are per UE. Hence, all time-frequency resources may be used anyway. Still, with increasing backhaul delay, all transmission opportunities cannot be used even if there are multiple active UEs.

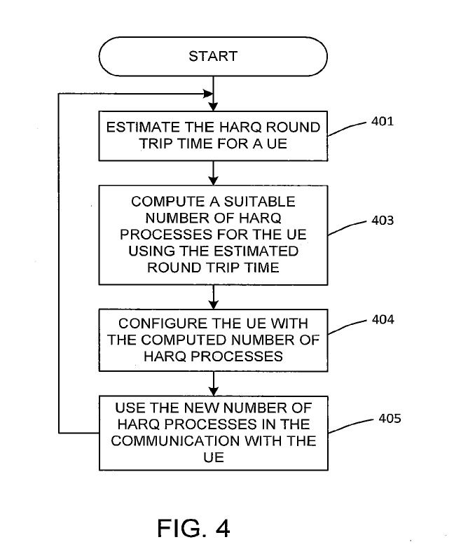

FIG. 4 is a flowchart of an embodiment of HARQ configuration for a UE. In one embodiment, the process illustrated in the flowchart relates to the UL. In one embodiment, the process illustrated in the flowchart relates to the DL. In one embodiment, the process illustrated in the flowchart relates to both the UL and the DL, i.e. the same number of HARQ processes is used in the UL and in the DL. The HARQ round trip time for a UE is estimated at block 401. Then a suitable number of HARQ processes for the UE is computed, at block 403, using the estimated HARQ round trip time. In some embodiments, other aspects, such as the UE and load distribution, the location and transmission/reception points of other UEs, etc., are taken into account when computing the number of HARQ process. After computing the number of HARQ processes, the UE is configured with the computed number of HARQ processes, at block 404. Finally, the new number of UL/DL HARQ processes are used in the UL/DL communication with the UE, at block 405. Then, the process is repeated for another UE. Eventually, the process may be repeated for the same UE, for instance if the nodes that transmit to or receive from the UE are changed.

In one embodiment, the number of HARQ processes used for a UE is adapted to the backhaul delays in the distributed network topology. In general, longer backhaul delays related to the communication with a UE would imply that more HARQ processes would be configured for the UE. Depending on the UE location, the load distribution etc., different nodes may serve different UEs in the downlink, and different nodes may serve different UEs in the uplink. Therefore, different UEs may experience different backhaul delays and therefore may need a different number of HARQ processes.

In some embodiments, the number of HARQ processes in the downlink is different from the number of HARQ processes in the uplink. In one embodiment, the number of HARQ processes in the downlink is equal to the number of HARQ processes in the uplink.

In some embodiments, the number of HARQ processes of a UE is configured by the network. In one embodiment, the number of HARQ processes for the downlink is configured separately from the number of HARQ processes for the uplink. In one embodiment, the number of HARQ processes for downlink is configured jointly with the number of HARQ processes for the uplink. Note that in some existing systems the number of HARQ processes can be reconfigured, for example as a function of the DL/UL configuration in TDD LTE. However, this configuration is valid for all UEs in the cell and is not UE specific.

This disclosure describes the HARQ processes for a UE connected to a single serving cell. This disclosure also describes the HARQ processes for a UE connected to a multiple cells. If a UE is connected to multiple cells, then this disclosure can apply to each of these cells, separately or jointly. In some embodiments, a UE connected to multiple cells will have separate numbers of HARQ processes for different serving cells. In some embodiments, a UE is configured with one number of HARQ processes to a first serving cell and a different number of HARQ processes to a second serving cell. In some embodiments, a number of HARQ processes configuration for a UE applies to a single serving cell.

In some embodiments, a number of HARQ processes configuration for a UE applies to multiple serving cells. In some embodiments, a UE is connected to three cells. The UE is configured with 8 DL HARQ processes and 16 DL HARQ processes, the number 8 applies to two (i.e. multiple) serving cells and the number 16 applies to a single serving cell. In other embodiments, different numbers of DL HARQ processes are used. In other embodiments, the UE is configured with a different number of HARQ processes to each of the three serving cells. In some embodiments, the number of HARQ processes for a UE connected to multiple cells is configured separately for each serving cell. In some embodiments, the same number of HARQ processes is separately configured for different serving cells for a UE connected to multiple cells.

Although described herein with reference to the embodiment in which there are 8 DL HARQ processes in LTE, the disclosure also applies to other examples such as an embodiment in which there are 16 or more DL HARQ processes and in which the total backhaul is significant, i.e. 10 ms or even 20+ ms in various embodiments.

Continuing the description of the embodiment, the LTE downlink is an example where a UE has 8 HARQ processes. The exemplary distributed network topology is such that a retransmission on a HARQ process can occur at the earliest 20 sub-frames after the first transmission, due to backhaul delays between some of the distributed network functions. If the number of HARQ processes for this UE is increased to 20, then the UE can be scheduled every sub-frame, instead of only on 40% of the sub-frames.

Furthermore, the set of other UEs can be taken into account when deciding on the number of HARQ processes, since transmission opportunities can be used by any UE. In one embodiment, the number of HARQ processes for all UEs can be decided jointly, in order to make sure that all transmission opportunities can be used.

Continuing the description of the exemplary embodiment described above, in one embodiment of the LTE downlink instead of a single UE, there are two UEs served by the same nodes. This means that both UEs have an overall HARQ process round-trip time of 20 sub-frames, as above. Since the HARQ processes of the different UEs can be used during different sub-frames, it may be sufficient to increase the total number of HARQ processes to 20, in order to be able to use every transmission opportunity. This can be achieved, for example, by increasing the number of HARQ processes for both UEs to 10, or by just increasing the number of HARQ processes of one of the UEs to 12, in various embodiments.

In the preceding embodiment, it is assumed that the number of HARQ process for a UE can be configured, at least semi-statically. As the UEs move they may need to be served by different nodes. Then the number of needed HARQ processes will be re-configured, as necessary in various embodiments.

The size of the soft bit memory buffer for the HARQ processes typically provides a limit to the data rate. In the LTE downlink, for example, the UE Category specifies the total memory buffer size in the UE for the downlink, which has to be shared by the 8 HARQ processes in the described embodiment, but HARQ processes that are greater than 8 in number, e.g. 16, 20+, are used in other embodiments. As the number of HARQ processes is reconfigured, the number of soft bits per HARQ process may also change. The number of soft bits can be explicitly configured or implicitly configured through the number of HARQ processes. In some embodiments, the total buffer size does not change with the number of HARQ processes (only the buffer size per process). A reduced buffer size per HARQ process does not reduce the L2 block size in many cases, according to the embodiment in which the buffer size is adapted to the maximum L2 block size. In many scenarios, the largest L2 block sizes can typically only be dedicated for use in special and rare conditions. In some embodiments, the total buffer size is equally divided among the configured HARQ processes, resulting in equal buffer size per process, or almost equal when the total buffer size is not evenly divisible by the configured number of HARQ processes. In other embodiments, the total buffer size changes with the configured number of HARQ processes. In some embodiments, the buffer size per process does not change with the configured number of HARQ processes.

In some embodiments, a scheduler takes the configured number of HARQ processes of a UE into account. For example, the number of configured HARQ processes can limit the L2 block size that the scheduler assigns. In some cases, this could lead to that not all available time-frequency resources need to be used to communicate the block with a desired reliability (e.g. target block error rate). In one embodiment, a scheduler handles this by reducing the transmit power, so that more of the available resources need to be used to communicate the block with a desired reliability. This can reduce the amount of interference in the system. In one embodiment, a scheduler handles a limited L2 block size by increasing the communication reliability (reduced code rate or lower order modulation or a combination thereof), so that the block error rate is reduced below a target level used otherwise. This may reduce the need for retransmissions. Although one or more embodiments of the invention have been described in the context of downlink, the invention is equally applicable to the uplink.

In asynchronous HARQ, such as in the LTE downlink, the HARQ process index is explicitly signalled in a scheduling assignment. A HARQ process index can be represented by a number of bits. In general, more bits are needed for the HARQ process index if there are more HARQ processes. For example, if there are 8 HARQ processes, 3 bits are needed to represent a HARQ process index, whereas 4 bits are needed if there are 16 HARQ processes.

In some embodiments, a scheduling assignment, including the HARQ process index and a cyclic redundancy check (CRC), is channel coded into a set of coded bits. The number of coded bits depends on the number of resources (e.g. time and frequency) that can be used in the communication of the scheduling assignment. For a given number of encoded bits, a varying number of bits for the HARQ process index can be handled in different ways.

In some embodiments, the different number of HARQ process index bits for different number of HARQ processes, is handled by simply adapting the effective channel coding rate (i.e. the decoding reliability) of the scheduling assignment accordingly. This assumes a certain set of resources (e.g. time and frequency) that can be used for communicating the scheduling assignment. In other words, a larger or smaller scheduling assignment (excluding any zero padding), due to more or fewer HARQ process index bits, is encoded into the same number of encoded bits. Hence, more HARQ processes may result in a higher coding rate and reduced decoding reliability. In some embodiments, the variable coding rate (and thereby reliability) may be, partly or fully, compensated for by allocating more resources (e.g. time and frequency) to the communication of the scheduling assignment or changing the modulation format. More resources would mean that more encoded bits could be communicated, and the channel coding rate could be reduced and the reliability increased. In some embodiments, the variable coding rate (and thereby reliability) may be, partly or fully, compensated for by increasing the transmit power of the scheduling assignment.

In other embodiments, a scheduling assignment includes other parameters or indices which may relate to the scheduled data rate. Examples include the modulation and coding scheme (MCS) index and the number of spatial layers (in LTE called transmission rank). In some embodiments, the number of bits for the scheduling assignment (excluding and zero padding) does not change with the number of HARQ processes. This is achieved by compensating for the changed number of bits for the HARQ process index by adjusting the number of bits of one or more other parameters or indices in the scheduling assignment accordingly. In some embodiments, an increased number of bits for the HARQ process index is compensated for by reducing the number of bits for the MCS. In one embodiment, the excluded MCS due to the reduced number of bits for the MCS is configurable. This may for example depend on which MCS a UE typically uses. In some embodiments, an increased number of bits for the HARQ process index is compensated for by reducing the number of bits for the transmission rank. In one embodiment, the excluded transmission ranks due to the reduced number of bits for the transmission rank is configurable. This may for example depend on which transmission ranks a UE typically uses.

In still other embodiments, In one embodiment, a scheduling assignment format does not change when the number of HARQ processes changes and number of bits used to represent a HARQ process index is the same for each number of HARQ processes. Instead, the HARQ process index is jointly given by the HARQ process index in the scheduling assignment and the time instant the scheduling assignment (or some other signal for example the corresponding data transmission) is transmitted or received. In one embodiment, the mapping between the HARQ process index bits and the time instant to a larger HARQ process index is predefined. In one embodiment, the mapping can be configured, for example together with the configuration of the number of HARQ processes.

As an example, consider the FDD LTE downlink where the HARQ process index in the scheduling assignment has 3 bits, i.e. it can represent 8 HARQ processes. Now, if a UE would be configured to have 16 HARQ processes for example, then the HARQ process index in the scheduling assignment can represent HARQ process 0-7 if the scheduling assignment is transmitted in an even sub-frame and HARQ process 8-15 if the scheduling assignment is transmitted in an odd sub-frame. This is illustrated in Table 3, where it is assumed that n is even. If 8 HARQ processes are configured, then the HARQ process index corresponds to the HARQ process index in the scheduling assignment. If 16 HARQ processes are configured on the other hand, then the HARQ process index corresponds to the HARQ process index only in the even sub-frames (n, n+2, n+4, n+6, where n is an even number). In the odd sub-frames (n+1, n+3, n+5), the HARQ process index is given by the HARQ process index in the scheduling assignment plus 8. In both sub-frames n+4 and n+5, the same HARQ process index, i.e. 3, is in the scheduling assignment. However, if the scheduled UE has 16 configured HARQ processes, the index in sub-frame n+4 corresponds to HARQ process index 3, whereas the index in sub-frame n+5 corresponds to HARQ process index 11. By rotating the sets of HARQ process indices in a round robin fashion, the waiting time before a retransmission can be scheduled is minimized.

TABLE 1
An example extension of the number of HARQ processes
from 8 to 16 for the LTE FDD downlink example.

| Subframe when | HARQ process | | |
|---|---|---|---|
| scheduling | index in | HARQ process | HARQ process |
| assignment | scheduling | index if 8 | index if 16 |
| is transmitted or | assignment | HARQ processes | HARQ processes |
| received | (0-7) | are configured | are configured |
| n | 4 | 4 | 4 |
| n + 1 | 7 | 7 | 15 |
| n + 2 | 1 | 1 | 1 |
| n + 3 | 0 | 0 | 8 |
| n + 4 | 3 | 3 | 3 |
| n + 5 | 3 | 3 | 11 |
| n + 6 | 7 | 7 | 7 |

In one embodiment, for example a TDD downlink, the set of HARQ process indices considered in one sub-frame is decided in a round robin fashion, only among the downlink sub-frames. For one TDD uplink embodiment, the sets would be changed in a round robin fashion, only among the uplink sub-frames. The downlink example is illustrated in Table 2. In this embodiment, the set of HARQ process indices does not change between consecutive sub-frames, as in the FDD example above, but between consecutive downlink sub-frames. By rotating the sets of HARQ process indices in a round robin fashion, the waiting time before a retransmission can be scheduled is minimized

TABLE 2
An example extension of the number of HARQ processes
from 8 to 16 for the LTE TDD downlink example.

| | | HARQ | | |
|---|---|---|---|---|
| Subframe when | | process | HARQ | HARQ |
| scheduling | | index in | process index | process index |
| assignment is | | scheduling | if 8 HARQ | if 16 HARQ |
| transmitted or | | assignment | processes are | processes are |
| received | DL/UL | (0-7) | configured | configured |
| n | DL | 4 | 4 | 4 |
| n + 1 | DL | 7 | 7 | 15 |
| — | UL | — | — | — |
| n + 3 | DL | 0 | 0 | 0 |
| n + 4 | DL | 3 | 3 | 11 |
| n + 5 | DL | 3 | 3 | 3 |
| n + 6 | DL | 7 | 7 | 15 |

In still other embodiments, a scheduling assignment format does not change when the number of HARQ processes changes and number of bits used to represent a HARQ process index is the same for each number of HARQ processes. Instead, the HARQ process index is jointly given by the HARQ process index in the scheduling assignment and the HARQ process indices of previous time instants. In one embodiment, the mapping between the HARQ process index bits in the scheduling assignment and the HARQ process indices of previous time instants to a larger HARQ process index is predefined. In one embodiment, the mapping can be configured, for example together with the configuration of the number of HARQ processes.

As an example, consider the FDD LTE downlink where the HARQ process index in the scheduling assignment has 3 bits, i.e. it can represent 8 values, for example 1-8. Now, if a UE would be configured to have n HARQ processes for example, then the HARQ process index X_{new} (between 0 and n−1) could for example be given by (X_{old}+Y) modulo n, where X_{old} is the HARQ process index the previous time the UE was scheduled and Y is the HARQ process index in the scheduling assignment. After the computation of X_{new}, the update X_{old}=X_{new} can be done. In some embodiments, the HARQ process indices of multiple, not necessarily subsequent, previous occasions that a UE was scheduled can be used to compute a new HARQ process index, together with a HARQ process index in a scheduling grant.

In some synchronous HARQ embodiments, the HARQ process index is not included in the scheduling assignment, as in the LTE uplink. Instead, the HARQ process index that the scheduling assignment refers to is implicitly given by the time instant (in LTE which sub-frame) that the scheduling assignment (or some other signal for example the corresponding data transmission) is transmitted or received. In one embodiment, different numbers of HARQ processes are solved by using different mappings from the time instant of a scheduling assignment transmission or reception and the corresponding HARQ process index. In one embodiment, the mappings are predefined. In one embodiment, the mapping can be configured, for example together with the configuration of the number of HARQ processes.

In the LTE FDD uplink for example, there are 8 HARQ processes (with indices 0-7 for example). Each of these HARQ processes correspond to a sub-frame where a corresponding scheduling grant can be transmitted or received. The sub-frame for a particular HARQ process occurs with period of 8 sub-frames. In one embodiment, the number of HARQ processes can be increased to 16, for example, by increasing this period to 16 sub-frames and periodically appending the sub-frames for HARQ processes 8-15 after the sub-frames for HARQ processes 0-7. This is illustrated in Table 3. In this example, a sub-frame transmitted or received in sub-frame n corresponds to HARQ process 0. If 8 HARQ processes are configured for the scheduled UE, a retransmission or new data transmission on the same HARQ process can be done at the earliest in sub-frame n+8. On the other hand, if 16 HARQ processes are configured for the scheduled UE, then a retransmission or new data transmission on the same HARQ process can be done at the earliest in sub-frame n+16. For a UE with 8 configured HARQ processes, a HARQ process can be used every 8 sub-frames, in this example. For a UE with 16 configured HARQ processes, a HARQ process can be used every 16 sub-frames, in this example.

TABLE 3
An example extension of the number of HARQ
processes from 8 to 16 for the LTE FDD uplink example.

| | | HARQ process |
|---|---|---|
| Subframe when scheduling | HARQ process index if 8 | index if 16 |
| assignment is transmitted or | HARQ processes are | HARQ processes |
| received | configured | are configured |
| n − 1 | 7 | 15 |
| n | 0 | 0 |
| n + 1 | 1 | 1 |
| n + 2 | 2 | 2 |
| n + 3 | 3 | 3 |
| n + 4 | 4 | 4 |
| n + 5 | 5 | 5 |
| n + 6 | 6 | 6 |
| n + 7 | 7 | 7 |
| n + 8 | 0 | 8 |
| n + 9 | 1 | 9 |
| n + 10 | 2 | 10 |
| n + 11 | 3 | 11 |
| n + 12 | 4 | 12 |
| n + 13 | 5 | 13 |
| n + 14 | 6 | 14 |
| n + 15 | 7 | 15 |
| n + 16 | 0 | 0 |
| n + 17 | 1 | 1 |
| n + 18 | 2 | 2 |
| n + 19 | 3 | 3 |

The network responds to an uplink transmission with a HARQ ACK/NACK. In one embodiment, the timing of the downlink transmission of the ACK/NACK corresponding to an uplink data transmission is moved later according to an increased number of HARQ processes. In the LTE FDD uplink, for example, the network responds with an ACK/NACK on PHICH 4 sub-frames after the PUSCH transmission on a HARQ process and consequential 4 sub-frames before the first possible retransmission on the same HARQ process. In one embodiment, if the number of HARQ processes is increased to 16, for example, the ACK/NACK (on PHICH, PDCCH or some other channel) is moved to 12 sub-frames after the PUSCH transmission, but still 4 sub-frames before the first possible retransmission on the same HARQ process.

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

One or more of the functions described in this document may be performed by an appropriately configured module. The term “module” as used herein, refers to software that is executed by one or more processors, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, one or more of the functions described in this document may be performed by means of computer program code that is stored in a “computer program product”, “computer-readable medium”, and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

1.-18. (canceled)

19. A system comprising:
a downlink transmitter unit;
an uplink receiver unit,
a downlink scheduler unit for scheduling downlink transmissions between the downlink transmitter unit and a user equipment (UE) using an asynchronous hybrid automatic repeat request (HARQ) protocol, and
a controller that allocates a plurality of asynchronous HARQ processes for communication between the downlink transmitter unit and the UE,
wherein a transmission scheduling assignment is sent from the downlink transmitter unit to the UE responsive to a determination made by the downlink scheduler unit for the downlink transmitter to transmit to the UE, and
wherein the transmission scheduling assignment includes a complete or partial HARQ process index associated with the plurality of asynchronous HARQ processes allocated by the controller.

20. The system as claimed in claim 19, wherein the HARQ process index comprises the complete HARQ process index and a number of HARQ process index bits in the transmission scheduling assignment is equal to a number of bits required to represent the plurality of allocated asynchronous HARQ processes.

21. The system as claimed in claim 20, wherein a size of the transmission scheduling assignment in coded bits does not change with different numbers of the asynchronous allocated HARQ processes, wherein a variable channel coding rate compensates for a variable number of bits for the HARQ process index.

22. The system as claimed in claim 21, wherein the variable channel coding rate compensates for the variable number of bits for the HARQ process index by the controller at least one of allocating an adjusted number of resources to the transmission scheduling assignment, changing a modulation format of the transmission scheduling assignment, and changing a transmit power of the transmission scheduling assignment.

23. The system as claimed in claim 20, wherein a number of uncoded bits in the transmission scheduling assignment does not change with different numbers of the allocated asynchronous HARQ processes, whereby a number of bits of one or more other parameters in the transmission scheduling assignment is adjusted to compensate for a variable number of bits of the HARQ process index.

24. The system as claimed in claim 23, wherein the one or more other parameters includes a modulation and coding scheme (MCS) parameter.

25. The system as claimed in claim 19, wherein the UE is connected to a plurality of serving cells and the controller allocates different numbers of the asynchronous HARQ processes for different serving cells of the plurality of serving cells.

26. The system as claimed in claim 19, wherein the HARQ process index comprises the partial HARQ process index and a fixed number of HARQ process index bits used to represent a HARQ process is the same for different numbers of HARQ processes and the fixed number of HARQ process index bits in the transmission scheduling assignment is less than a number of bits required to represent the plurality of allocated asynchronous HARQ processes.

27. The system as claimed in claim 26, wherein the HARQ process index obtained by the UE is jointly given by the HARQ process index in the transmission scheduling assignment and a time instant that the transmission scheduling assignment is transmitted.

28. The system as claimed in claim 26, wherein the HARQ process index is obtained by the UE by combining the partial HARQ process index received in the transmission scheduling assignment with a previously used one or more HARQ process indices.

29. The system as claimed in claim 19, wherein the UE includes soft bit buffers, a total soft bit buffer size in the UE for all of the allocated asynchronous HARQ processes does not change for different numbers of asynchronous HARQ processes and the soft bit buffer size per asynchronous HARQ process changes for different numbers of the asynchronous HARQ processes.

30. The system as claimed in claim 29, wherein the downlink scheduler unit accommodates the changes in the soft bit buffer size per asynchronous HARQ process, by limiting scheduled layer 2 (L2) block size in the transmission scheduling assignment, such that a maximum scheduled L2 block size for the asynchronous HARQ process is adapted to the soft bit buffer size of the asynchronous HARQ process.

31. The system as claimed in any one of the preceding claims, wherein at least one of the units is located at a physically separate location from others of the units, the at least one of the units communicates with the others of the units over a backhaul and the system is a long term evolution (LTE) system.

32. The system as claimed in claim 19, wherein at least one of the units is located at a physically separate location from others of the units and communicates with the others of the units over a backhaul.

33. The system as claimed in claim 32, wherein the controller allocates a first number of asynchronous HARQ processes regardless of any communication delays caused by the backhaul, and a second number of asynchronous HARQ processes according to any communication delays caused by the backhaul.

34. The system as claimed in claim 33, wherein the UE is connected to at least a first serving cell and a second serving cell and the controller allocates the first number of asynchronous HARQ processes for the first serving cell the second number of HARQ processes to the second serving cell

35. The system as claimed in claim 34, wherein the system is a long term evolution (LTE) system.

36. A system, which comprises:
a downlink transmitter unit;
an uplink receiver unit,
a downlink scheduler unit for scheduling downlink transmissions between the downlink transmitter unit and a user equipment (UE) using an asynchronous hybrid automatic repeat request (HARQ) protocol, at least one of the units being located at a physically separate location from others of the units and communicating with the others of the units over a backhaul, and
a controller that allocates a plurality of asynchronous HARQ processes for communication between the downlink transmitter unit and the UE,
wherein a transmission scheduling assignment is sent from the downlink transmitter unit to the UE responsive to a determination made by the downlink scheduler unit for the downlink transmitter to transmit to the UE,
the controller allocates a first number of asynchronous HARQ processes regardless of any communication delays caused by the backhaul for a first serving cell connected to the UE, and a second number of asynchronous HARQ processes according to any communication delays caused by the backhaul to a second serving cell connected to said UE,
the system is a long term evolution (LTE) system, and
the transmission scheduling assignment includes a complete or partial HARQ process index associated with the plurality of asynchronous HARQ processes allocated by the controller.

37. A method of allocating a number of asynchronous hybrid automatic repeat request (HARQ) processes in a system including a downlink transmitter unit, a downlink scheduler unit and an uplink receiver unit, the method comprising:
scheduling downlink transmissions between the downlink transmitter unit and a user equipment (UE) using an asynchronous hybrid automatic repeat request (HARQ) protocol,
allocating a plurality of asynchronous HARQ processes for communication between the downlink transmitter unit and the UE,
sending a transmission scheduling assignment from the downlink transmitter unit to the UE responsive to a determination made by the downlink scheduler unit for the downlink transmitter to transmit to the UE, and
wherein the transmission scheduling assignment includes a complete or partial HARQ process index associated with the plurality of allocated asynchronous HARQ processes.

38. The method as claimed in claim 37, wherein the HARQ process index comprises the complete HARQ process index and a number of HARQ process index bits in the transmission scheduling assignment is equal to a number of bits required to represent the plurality of allocated asynchronous HARQ processes.

39. The method as claimed in claim 38, further comprising maintaining a same size of the transmission scheduling assignment in coded bits, for different numbers of the asynchronous allocated HARQ processes and compensating for a variable number of bits for the HARQ process index using a variable channel coding rate.

40. The method as claimed in claim 39, wherein compensating for a variable number of bits for the HARQ process index using a variable channel coding rate, includes at least one of allocating an adjusted number of resources to the transmission scheduling assignment, changing a modulation format of the transmission scheduling assignment, and changing a transmit power of the transmission scheduling assignment.

41. The method as claimed in claim 38, further comprising maintaining a same number of uncoded bits in the transmission scheduling assignment for different numbers of the allocated asynchronous HARQ processes by adjusting a number of bits of one or more other parameters in the transmission scheduling assignment to compensate for a variable number of bits of the HARQ process index.

42. The method as claimed in claim 37, wherein the UE is connected to a plurality of serving cells, and allocating a plurality of asynchronous HARQ processes comprises a controller allocating different numbers of the asynchronous HARQ processes for different serving cells of the plurality of serving cells.

43. The method as claimed in claim 37, wherein the HARQ process index comprises the partial HARQ process index and further comprising using a fixed number of HARQ process index bits to represent a HARQ process for different numbers of HARQ processes, and wherein the fixed number of HARQ process index bits in the transmission scheduling assignment is less than a number of bits required to represent the plurality of allocated asynchronous HARQ processes.

44. The method as claimed in claim 43, further comprising the UE obtaining the HARQ process index by combining the partial HARQ process index received in the transmission scheduling assignment with a previously used one or more HARQ process indices.

45. The method as claimed in claim 37, wherein the UE includes soft bit buffers, and further comprising maintaining a same total soft bit buffer size in the UE for all of the allocated asynchronous HARQ processes for different numbers of asynchronous HARQ processes, and changing the soft bit buffer size per asynchronous HARQ process for different numbers of asynchronous HARQ processes.

46. The method as claimed in claim 37, wherein at least one of the units is located at a physically separate location from others of the units and communicates with the others of the units over a backhaul.

47. The method as claimed in claim 46, wherein allocating comprises allocating a first number of asynchronous HARQ processes regardless of any communication delays caused by the backhaul, and allocating a second number of asynchronous HARQ processes according to any communication delays caused by the backhaul.

48. A method of allocating a number of asynchronous hybrid automatic repeat request (HARQ) processes in a Long Term Evolution (LTE) system including a downlink transmitter unit, a downlink scheduler unit and an uplink receiver unit, wherein at least one of the units is located at a physically separate location from others of the units, and wherein the at least one of the units communicates with the others of the units over a backhaul, the method comprising:
determining a delay caused by the backhaul in retransmitting blocks for an asynchronous HARQ process,
transmitting with each said block a HARQ process index that identifies the asynchronous HARQ process associated with the block; and,
allocating extra processes based upon the delay.

49. The method as claimed in claim 48, wherein the HARQ process index identifies the asynchronous HARQ process by implicit time association or by incremental association.
